(19) United States
(12) Patent Application Publication
(10) Pub. No.: US 2024/0219667 A1
(43) Pub. Date: Jul. 4, 2024

(54) FIBER DISTRIBUTION ENCLOSURE HAVING A SECOND ENCLOSURE THEREIN AND STRUCTURALLY CONFIGURED TO MAINTAIN THE SECOND ENCLOSURE IN A RAISED POSITION SO AS TO PROVIDE ENHANCED ACCESS TO THE SECOND ENCLOSURE

(71) Applicant: PPC BROADBAND, INC., East Syracuse, NY (US)

(72) Inventors: Sandeep PULIYANKULANGARA, Ernakulam (KL) (IN); Boby ANTONY, Kochi (KL) (IN)

(73) Assignee: PPC BROADBAND, INC., East Syracuse, NY (US)

(21) Appl. No.: 18/401,485

(22) Filed: Dec. 30, 2023

(30) Foreign Application Priority Data
Dec. 30, 2022 (IN) 202221077053

(51) Int. Cl. G02B 6/44

(52) U.S. Cl. CPC G02B 6/4442; G02B 6/445

(57) ABSTRACT

A fiber distribution enclosure may include a base portion, a cover portion, and an enclosure portion structurally configured to be pivotally coupled with the base portion at an interior. The enclosure portion may include an adapter portion that is structurally configured to couple a fiber optic cable from outside of the enclosure portion with a fiber optic cable of a fiber distribution portion in the enclosure portion. The first enclosure portion may be structurally configured to be pivoted relative to the base portion between a lowered position and a raised position, and the first enclosure portion may include an engagement portion structurally configured to engage a receiving portion of the mounting portion in the raised position such that the engagement portion and the receiving portion are structurally configured to maintain the first enclosure portion in the raised position so as to provide enhanced access to the adapter portion.

### CROSS-REFERENCE TO RELATED APPLICATION

This application claims the benefit of Indian Provisional Application No. 202221077053, filed Dec. 30, 2022, pending, the disclosure of which is hereby incorporated by reference herein in its entirety.

### TECHNICAL FIELD

The disclosure relates generally to a fiber distribution enclosure and, in particular, to a fiber distribution enclosure having a secured enclosure therein.

### BACKGROUND

As demand for telecommunications increases, fiber optic networks are being extended in more and more areas. Conventionally, fiber optic enclosures are used to provide a subscriber access point to the fiber optic network. Such a fiber optic enclosure is connected to the fiber optic network through a subscriber cable connected to a network hub.

In many situations, any technician can access the contents of the enclosure. However, in some circumstances, a service provider or other entity may wish to limit access to certain contents of the enclosure. For example, a service provider may wish to configure fibers, connectors, adapters, and/or a splitter to a desired configuration and prevent an installer or other technician from tampering with the desired configuration.

Accordingly, it may be desirable to provide a fiber distribution enclosure that is configured to contain a secure enclosure, wherein the enclosure includes a lock such that only desired persons have access to the contents of the secure enclosure. It may also be desirable to provide a secure enclosure that is configured to move between a lowered position for compact storage and a raised position that provides enhanced access to adapters mounted on the secure enclosure.

### SUMMARY

According to various aspects of the disclosure, a fiber distribution enclosure may include a base portion having a back wall portion and a side wall portion structurally configured to define an interior, a cover portion configured to be pivotally coupled with the base portion so as to pivot about a first axis, a mounting portion configured to be fixedly coupled with the back wall of the base portion in the interior of the base portion, and an enclosure portion configured to be pivotally coupled with the mounting portion in the interior of the base portion. The enclosure portion may include a first enclosure portion configured to be pivotally coupled with a second enclosure portion about a second axis perpendicular to the first axis, the first enclosure portion may include a wall portion that is structurally configured to define an interior of the enclosure portion, and the second enclosure portion may be structurally configured to block access to the interior of the enclosure portion. The enclosure portion may be structurally configured to enclose a fiber distribution portion in the interior of the enclosure portion, and the enclosure portion may include a locking portion that is structurally configured to lock the second enclosure portion with the first enclosure portion so as to prevent an unauthorized person from accessing the fiber distribution portion. The wall portion of the first enclosure portion may include an adapter portion that is structurally configured to couple a fiber optic cable from outside of the enclosure portion with a fiber optic cable of the fiber distribution portion so as to permit a person to couple a fiber optic cable to the fiber distribution portion without accessing the fiber distribution portion. The base portion may include a port portion that is structurally configured to permit a fiber optic cable to pass there through for coupling with the adapter portion, and the cover portion may be structurally configured to be moved between a closed position, which prevents access to the enclosure portion, and an open position, which permits access to the enclosure portion. The first enclosure portion may be structurally configured to be moved relative to the base portion between a lowered position and a raised position, and the first enclosure portion may include an engagement portion structurally configured to engage a receiving portion of the mounting portion such that the engagement portion and the receiving portion are structurally configured to maintain the first enclosure portion in the raised position so as to provide enhanced access to the adapter portion of the enclosure portion when the cover portion is in the open position

In some aspects of the fiber distribution enclosure, the engagement structure may comprise a biasing portion extending from the first enclosure portion, and the receiving portion may be structurally configured to receive the biasing portion.

In some aspects of the fiber distribution enclosure, the biasing portion may comprise a spring-biased plunger mounted in a side wall of the first enclosure portion, and the receiving portion may comprise a hole or notch in the mounting portion.

In some aspects of the fiber distribution enclosure, the mounting portion may comprise two arms and each arm includes a notch, the enclosure portion may comprise two pins extending in an opposite direction from two opposite side walls of the enclosure, and the arms may be spaced apart from one another by a distance that is large enough to permit the enclosure portion to be received therebetween and small enough such that the notches are structurally configured to receive the pins so as to permit the enclosure portion to pivot relative to the mounting portion.

In some aspects of the fiber distribution enclosure, each notch may be configured to require that the pin be moved in two directions in order to remove the pin from the notch so as to prevent inadvertent removal of the pin from the notch.

In some aspects of the fiber distribution enclosure, the adapter portion may include a single fiber adapter and a multifiber adapter, the fiber distribution portion may include a single fiber adapter, a splitter, and a parking portion, and the port portion may include input and output ports each configured to receive a multifiber cable, and a drop cable portion.

According to various aspects of the disclosure, a fiber distribution enclosure may include a base portion, a cover portion structurally configured to be coupled with the base portion, and an enclosure portion structurally configured to be pivotally coupled with the base portion at an interior of the base portion. The enclosure portion may include a first enclosure portion structurally configured to be coupled with a second enclosure portion so as to prevent an unauthorized person from accessing a fiber distribution portion in the interior of the enclosure portion, and the enclosure portion may include an adapter portion that is structurally configured to couple a fiber optic cable from outside of the enclosure portion with a fiber optic cable of the fiber distribution portion so as to permit a person to couple a fiber optic cable to the fiber distribution portion without accessing the fiber distribution portion. The first enclosure portion may be structurally configured to be pivoted relative to the base portion between a lowered position and a raised position, and the first enclosure portion includes an engagement portion structurally configured to engage a receiving portion of the mounting portion in the raised position such that the engagement portion and the receiving portion are structurally configured to maintain the first enclosure portion in the raised position so as to provide enhanced access to the adapter portion of the enclosure portion when the cover portion is in an open position that permits access to the interior of the base portion.

In some aspects of the fiber distribution enclosure, the engagement portion may comprise a biasing portion extending from the first enclosure portion, and the receiving portion may be structurally configured to receive the biasing portion.

In some aspects of the fiber distribution enclosure, the biasing portion may comprise a spring-biased plunger mounted in a side wall of the first enclosure portion, and the receiving portion may comprise a hole or notch in the base portion.

In some aspects of the fiber distribution enclosure, the base portion may include a mounting portion comprising two arms and each arm includes a notch, and the enclosure portion comprises two pins extending in an opposite direction from two opposite side walls of the enclosure, and the arms may be spaced apart from one another by a distance that is large enough to permit the enclosure portion to be received therebetween and small enough such that the notches are structurally configured to receive the pins so as to permit the enclosure portion to pivot relative to the mounting portion.

In some aspects of the fiber distribution enclosure, the mounting portion may be structurally configured to be coupled with a wall of the base portion.

In some aspects of the fiber distribution enclosure, each notch may be configured to require that the pin be moved in two directions in order to remove the pin from the notch so as to prevent inadvertent removal of the pin from the notch.

In some aspects of the fiber distribution enclosure, the base portion may include a port portion that is structurally configured to permit a fiber optic cable to pass there through for coupling with the adapter portion.

In some aspects of the fiber distribution enclosure, the adapter portion may include a single fiber adapter and a multifiber adapter, the fiber distribution portion may include a single fiber adapter, a splitter, and a parking portion, and the port portion may include input and output ports each configured to receive a multifiber cable, and a drop cable portion.

According to various aspects of the disclosure, a fiber distribution enclosure may include a base portion, a cover portion structurally configured to be coupled with the base portion, and an enclosure portion structurally configured to be pivotally coupled with the base portion at an interior of the base portion. The enclosure portion may include an adapter portion that is structurally configured to couple a fiber optic cable from outside of the enclosure portion with a fiber optic cable of a fiber distribution portion in the enclosure portion so as to permit a person to couple a fiber optic cable to the fiber distribution portion without accessing the fiber distribution portion. The first enclosure portion may be structurally configured to be pivoted relative to the base portion between a lowered position and a raised position, and the first enclosure portion may include an engagement portion structurally configured to engage a receiving portion of the mounting portion in the raised position such that the engagement portion and the receiving portion are structurally configured to maintain the first enclosure portion in the raised position so as to provide enhanced access to the adapter portion of the enclosure portion when the cover portion is in an open position that permits access to the interior of the base portion.

In some aspects of the fiber distribution enclosure, the engagement portion may comprise a biasing portion extending from the first enclosure portion, and the receiving portion may be structurally configured to receive the biasing portion.

In some aspects of the fiber distribution enclosure, the biasing portion may comprise a spring-biased plunger mounted in a side wall of the first enclosure portion, and the receiving portion may comprise a hole or notch in the base portion.

In some aspects of the fiber distribution enclosure, the base portion may include a mounting portion comprising two arms and each arm includes a notch, the enclosure portion may comprise two pins extending in an opposite direction from two opposite side walls of the enclosure, and the arms may be spaced apart from one another by a distance that is large enough to permit the enclosure portion to be received therebetween and small enough such that the notches are structurally configured to receive the pins so as to permit the enclosure portion to pivot relative to the mounting portion.

In some aspects of the fiber distribution enclosure, the mounting portion may be structurally configured to be coupled with a wall of the base portion.

In some aspects of the fiber distribution enclosure, each notch may be configured to require that the pin be moved in two directions in order to remove the pin from the notch so as to prevent inadvertent removal of the pin from the notch.

In some aspects of the fiber distribution enclosure, the base portion may include a port portion that is structurally configured to permit a fiber optic cable to pass there through for coupling with the adapter portion.

In some aspects of the fiber distribution enclosure, the adapter portion may include a single fiber adapter and a multifiber adapter, the fiber distribution portion may include a single fiber adapter, a splitter, and a parking portion, and the port portion may include input and output ports each configured to receive a multifiber cable, and a drop cable portion.

In some aspects of the fiber distribution enclosure, the enclosure portion may be structurally configured to prevent an unauthorized person from accessing a fiber distribution portion in an interior of the enclosure portion.

Various aspects of the fiber distribution enclosure, as well as other embodiments, objects, features, and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a perspective view of an exemplary fiber distribution enclosure with a secured enclosure therein in a lowered position according to various aspects of the disclosure.

FIG. 2 is a top view of the fiber distribution enclosure of FIG. 1.

FIG. 3 is a perspective view of the fiber distribution enclosure with a secured enclosure therein in a raised position.

FIG. 4 is a perspective view of the secured enclosure of the fiber distribution enclosure of FIG. 1 in a lowered position.

FIG. 5 is a perspective view of the secured enclosure of the fiber distribution enclosure of FIG. 1 in a raised position.

FIG. 6 is a side cross sectional view of the fiber distribution enclosure of FIG. 1.

FIG. 7 is a side cross sectional view of the fiber distribution enclosure of FIG. 3.

FIG. 8 is a perspective view of the secured enclosure of the fiber distribution enclosure of FIG. 1 in an open position.

FIG. 9 is an enlarged perspective view of a portion of an outside of the secured enclosure of the fiber distribution enclosure of FIG. 1.

FIG. 10 is a perspective view of the secured enclosure of the fiber distribution enclosure of FIG. 1 populated with adapters and in an open position.

FIG. 11 is a side view of a wall of the secured enclosure of the fiber distribution enclosure of FIG. 1 populated with adapters.

FIG. 12 is an end view of the fiber distribution enclosure of FIG. 1.

FIG. 13 is a top view of the fiber distribution enclosure of FIG. 1 in an open position with the secured enclosure in a lowered and open position.

FIG. 14 is an enlarged perspective view of the fiber distribution enclosure of FIG. 13.

FIG. 15 is an enlarged top view of the fiber distribution enclosure of FIG. 13.

FIG. 16 is a schematic illustration of the exemplary configuration of fibers shown in FIGS. 13-15.

FIG. 17 is a schematic illustration of a second exemplary configuration of fibers, connectors, adapters, and splitter in the secured enclosure of the fiber distribution enclosure.

FIG. 18 is a schematic illustration of a third exemplary configuration of fibers in the secured enclosure of the fiber distribution enclosure.

FIG. 19 is an enlarged perspective view of an end wall of the fiber distribution enclosure of FIG. 1 with an exemplary port protector separated from a port.

FIG. 20 is an enlarged perspective view of an end wall of the fiber distribution enclosure of FIG. 1 illustrating a tool for coupling and removing the exemplary port protector of FIG. 19.

### DETAILED DESCRIPTION OF EMBODIMENTS

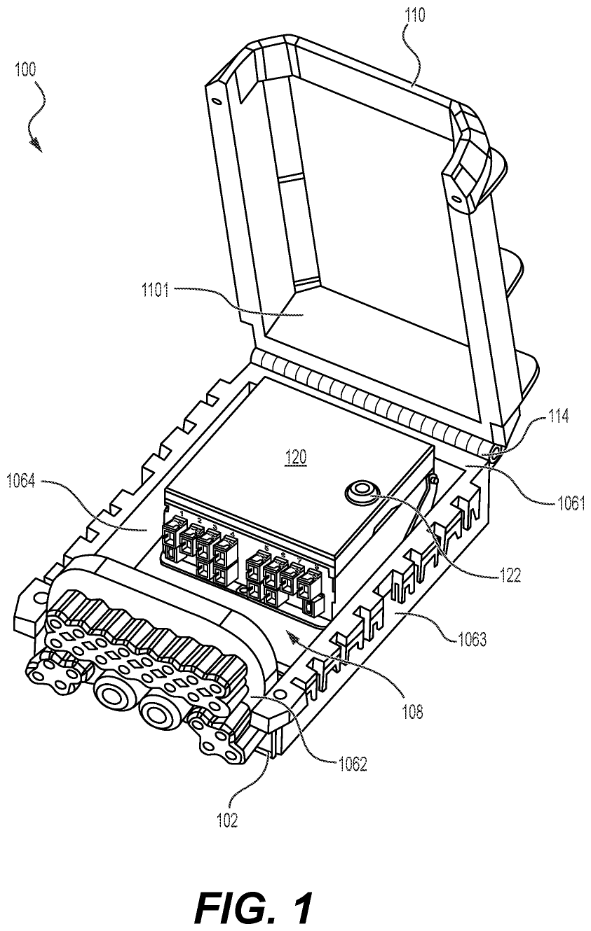

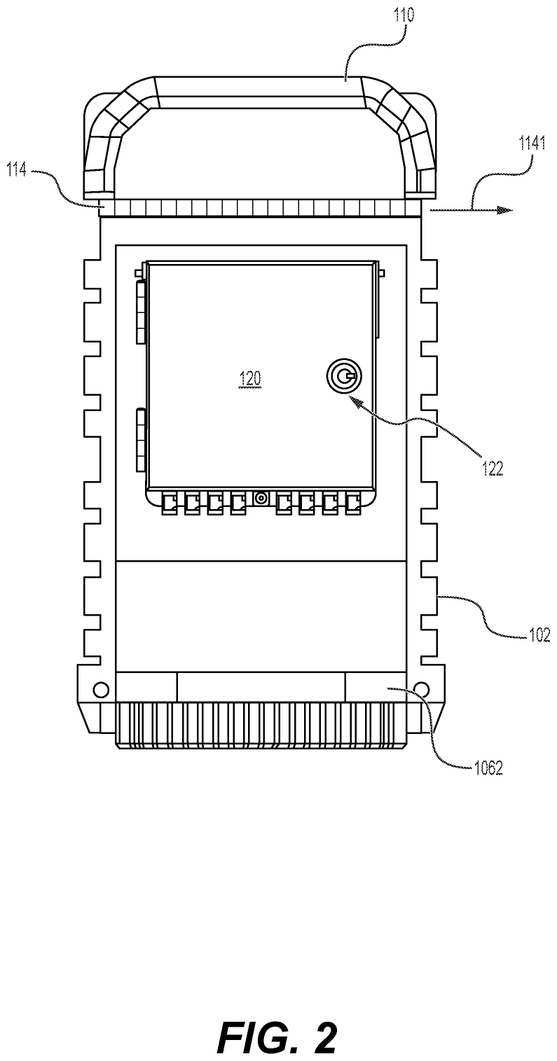

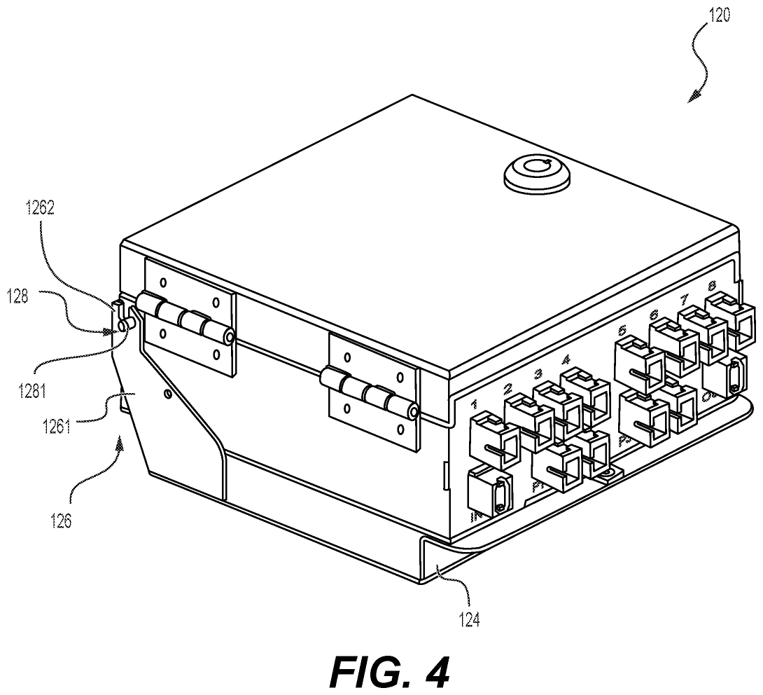

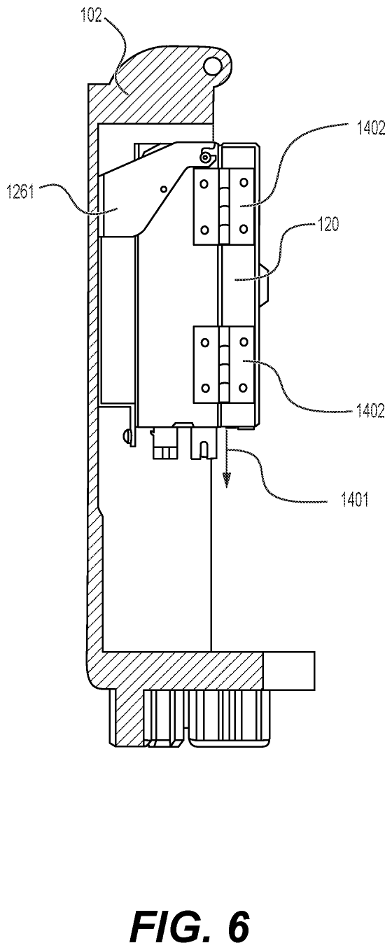

FIGS. 1-16 illustrate an exemplary telecommunications box, for example, a fiber distribution enclosure 100 that is part of a fiber optic telecommunications system. The enclosure 100 includes a first enclosure portion or base portion 102 having a back wall 104 and four side walls 1061, 1062, 1063, 1064. The back wall 104 and the four side walls 1061-1064 define an interior or cavity 108, which can be closed by a second enclosure portion or cover portion 110. The first and enclosure second portions 102, 110 can be closed to form a perimeter seal. In some aspects, the enclosure 100 may be IP-68 outdoor rated to provide a ruggedized fiber enclosure. In some aspects, the enclosure 100 may be constructed of a rigid plastic material.

The first portion 102 and the second portion 110 are configured to be pivotally coupled along a first side wall 1061 of the first portion 102 and a first side wall 1101 of the second portion 110. For example, the first portion 102 and the second portion 110 may be coupled to one another by a hinge portion 114 having a hinge axis 1141.

The enclosure 100 includes an enclosure 120 in the interior 108. The enclosure 120 may be a secured enclosure, for example, an enclosure that can be secured with a locking portion 122 to prevent unauthorized persons from accessing an interior of the enclosure. The locking portion 122 may be a keyed or passcode protected lock, and dissemination of an access key or passcode can be limited to authorized persons designated by, for example, a service provider. In some aspects, the enclosure 120 may comprise a metal enclosure.

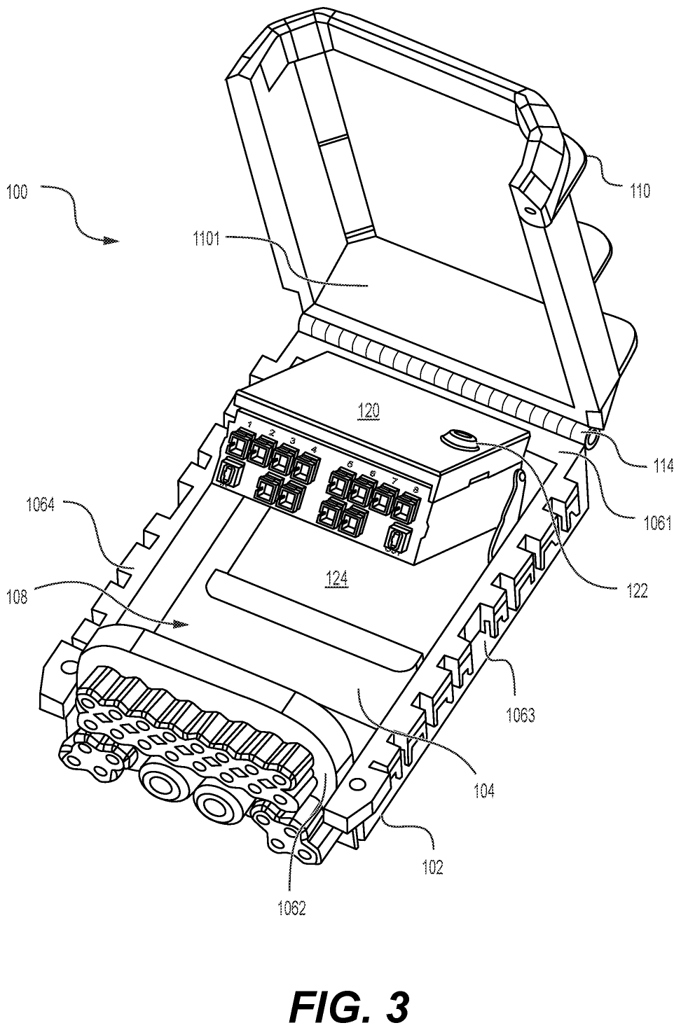

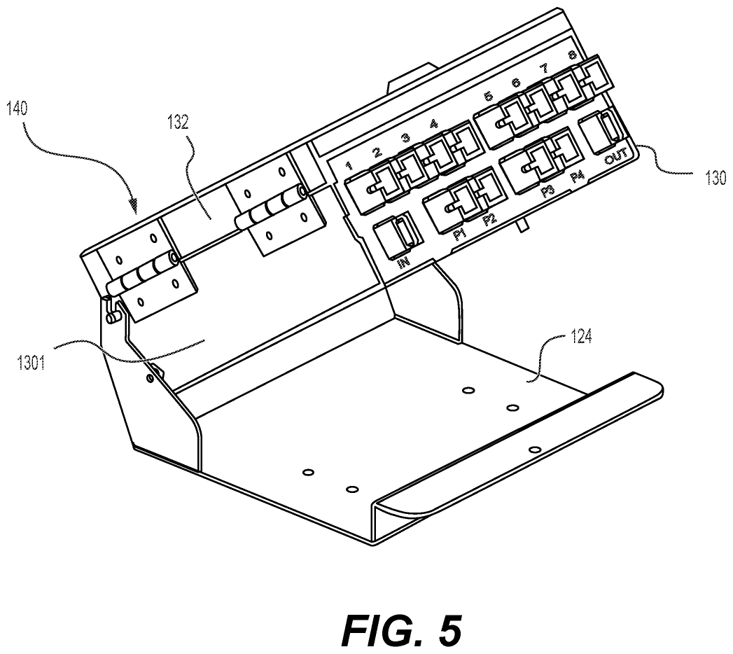

As best illustrated in FIGS. 3 and 5, the enclosure 100 may include a mounting portion 124, for example, a bracket, configured to be fixedly coupled with the back wall 104 of the first portion 102. In some aspects, the base portion 124 may be removably coupled with the back wall 104 via a fastener (not shown) such that that the base portion 124 can be removed. In some aspects, the base portion 124 may be permanently coupled with the back wall 104, for example, by partial overmolding.

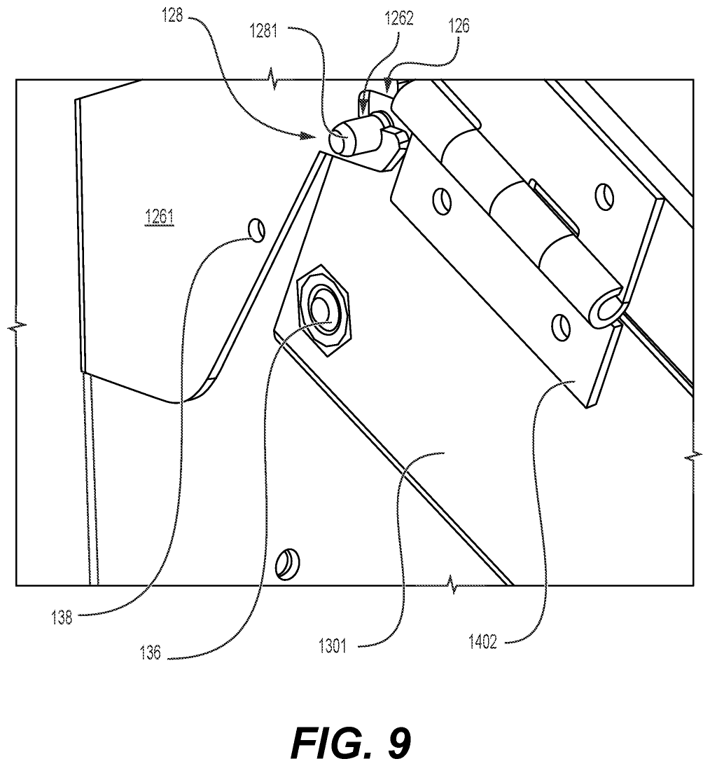

The enclosure 120 may be pivotally coupled with the base portion 124. For example, the base portion 124 may include a receiving portion 126 configured to receive an engagement portion 128 of the enclosure 120. As best illustrated in FIG. 9, the receiving portion 126 may comprise an arm 1261 extend away from the back wall 104 and a notch or cutout 1262 in the arm 1261, and the engagement portion 128 may comprise a pin or projection 1281 extending from a wall of the enclosure 120. The notch or cutout 1262 may be configured so as to require that the pin or projection 1281 be moved in two directions in order to remove the pin or projection 1281 from the notch or cutout 1262 so as to prevent inadvertent removal. As illustrated, the receiving portion 126 may comprise two arms 1261 and two notches or cutouts 1262, and the engagement portion 128 may comprise two pins or projections 1281 extending in opposite direction from two opposite side walls of the enclosure 120. The arms 1261 are spaced apart from one another by a distance that is large enough to permit the enclosure 120 to be disposed therebetween and small enough such that the notches or cutouts 1262 are capable of receiving the pins or projections 1281.

The enclosure 120 includes a first portion or base portion 130 and a second portion or cover portion 132. The first portion 130 includes four side walls 1301, 1302, 1303, 1304 that define an interior or cavity 134, which can be closed by the second portion 132. In some aspects, the pins or projections 1281 may extend from the two opposed side walls 1301 and 1302. The second portion includes four side walls 1321, 1322, 1323, 1324. The first portion 130 and the second portion 132 are configured to be pivotally coupled along the second side wall 1302 of the first portion 130 and the second side wall 1322 of the second portion 132. For example, the first portion 130 and the second portion 132 may be coupled to one another by a hinge portion 140 having a hinge axis 1401. In some aspects, the hinge portion 140 may comprise a plurality of hinges 1402. As illustrated, the hinge axis 1401 may be perpendicular to the hinge axis 1141. In other aspects, the first and second portions 130, 132 may be coupled to one another by a hinge having a hinge axis that is parallel with the hinge axis 1141.

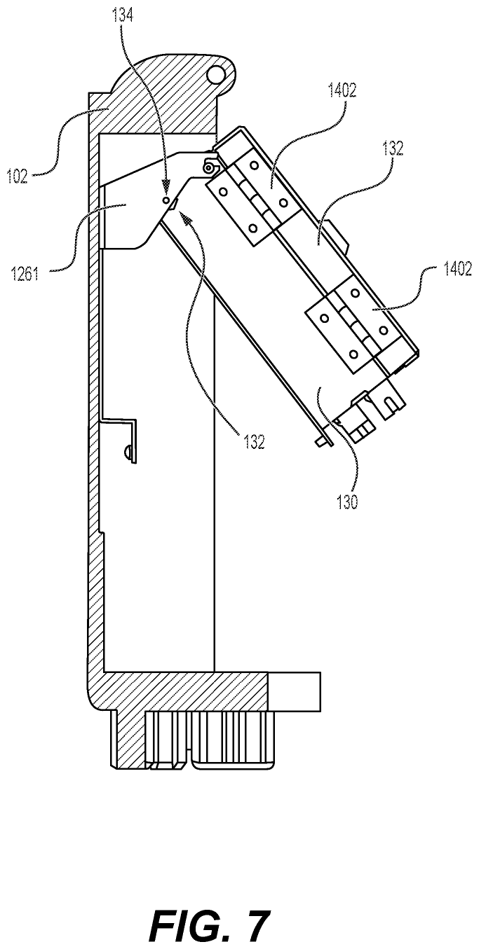

The first portion 130 is moveable between a lowered position, as illustrated in FIGS. 1, 2, 4, and 6, and a raised position, as illustrated in FIGS. 3, 5, and 7. The first portion 130 and the receiving portion 126 may be configured to cooperate to maintain the first portion 130 in the raised position. For example, as best illustrated in FIGS. 7-9, the first portion 130 may include an engagement structure 132 configured to engage an engagement feature 134 of the arm 1261. In some aspects, the engagement structure 132 may comprise a biased plunger 136 mounted in the first side wall 1301 of the first portion 130, and the engagement feature 134 may comprise a hole, opening, or notch 138 in the arm 1261. The plunger 136 may be a spring loaded plunger that is biased toward the arm 1261 such that the plunger 136 is configured to be received in the hole 138 when the plunger 136 and the hole 138 are aligned with one another. In some aspects, the engagement structure 132 may comprise biased plungers 136 mounted in the first and second side walls 1301, 1302 of the first portion 130, and the engagement feature 134 may comprise holes 138 in the arms 1261.

Referring now to FIG. 21, another exemplary fiber distribution node 200 with an enclosure therein is illustrated. The node 200 includes a first node portion or base portion 202 having a back wall 204 and side walls 2061, 2062, 2063, with the fourth wall removed for illustrative purposes. The back wall 204 and the side walls 2061-2063 define an interior or cavity 208, which can be closed by a second node portion or cover portion 210. The first and second node portions 202, 210 can be closed to form a perimeter seal. In some aspects, the node 200 may be IP-68 outdoor rated to provide a ruggedized fiber enclosure. In some aspects, the node 200 may be constructed of a rigid plastic material.

The first portion 202 and the second portion 210 are configured to be pivotally coupled along a first side wall 2061 of the first portion 202 and a first side wall 2101 of the second portion 210. For example, the first portion 202 and the second portion 210 may be coupled to one another by a hinge portion 214 having a hinge axis 2141.

The node 200 includes an enclosure 220 in the interior 208. The enclosure 220 may be a secured enclosure, for example, an enclosure that can be secured with a locking portion 222 to prevent unauthorized persons from accessing an interior of the enclosure 220. The locking portion 222 may be a keyed or passcode protected lock, and dissemination of an access key or passcode can be limited to authorized persons designated by, for example, a service provider. In some aspects, the enclosure 220 may comprise a metal enclosure.

As best illustrated in FIGS. 3 and 5, the node 200 may include a mounting portion 224, for example, a bracket, configured to be fixedly coupled with the back wall 204 of the first portion 202. In some aspects, the mounting portion 224 may be removably coupled with the back wall 204 via a fastener (not shown) such that that the mounting portion 224 can be removed. In some aspects, the mounting portion 224 may be integral with or permanently coupled with the back wall 204, for example, by partial overmolding. The mounting portion 224 may be similar to the mounting portion 124 described above, and the enclosure 220 may be pivotally coupled with the mounting portion 224, as discussed above with respect to the enclosure 120.

The enclosure 220 includes a first portion or base portion 230 and a second portion or cover portion 232, similar to the enclosure 120 described above, and the first portion 230 is configured to be moved relative to the mounting portion 224 between a lowered position, as illustrated in FIG. 21, and a raised position, as illustrated in FIG. 22. The mounting portion 224 may include an engagement portion receiving portion 234 configured to receive an engagement portion 232 of the first portion 230. For example, the engagement portion 232 may comprise an extension arm pivotally coupled with the first portion 230, and the engagement portion receiving portion 234 may comprise a slot 2341 configured to receive a portion of the engagement portion 232. The engagement portion 232 is sized and arranged such that an end portion 2325 of the engagement portion 232 is configured to engage the back wall 204 of the first node portion 202 when the engagement portion 232 is received in the engagement portion receiving portion 234 so as to maintain the first portion 230 in the raised position.

As best illustrated in example of FIGS. 23 and 24, the mounting portion 224 includes a first wall portion 2241 that extends perpendicular to the back wall 204 and a second wall portion 2242 that extends from an end of the first wall portion 2241 in a direction parallel to the back wall 204. The engagement portion receiving portion 234 comprises an end portion of the second wall portion 2242 that includes the slot 2341 and a third wall portion 2243 that extends from the second wall portion 2242 toward the back wall 204 but terminates short of the back wall 204 such that the end portion 2325 of the engagement portion 232 can pass under the third wall portion 2243 when moving the first portion 230 to the raised position.

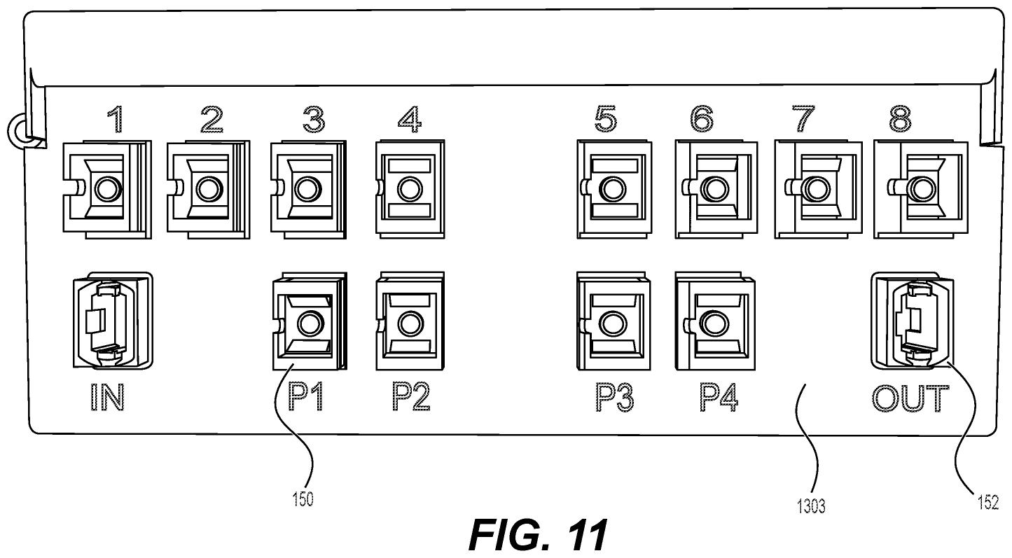

The engagement portion 232 includes a first portion 2321 having a first end pivotally coupled with the base portion 230 of the enclosure 220 and extending perpendicular to the back wall 204. The engagement portion includes a second portion 2322 extending from a second end of the first portion 2321 in a direction perpendicular to the first portion 2321, and a third portion 2323 extending from the second portion 2322 in a direction perpendicular to the second portion 2322 and parallel with the first portion 2321. The end portion 2325 of the engagement portion 232 extend from the third portion in a direction perpendicular to the first and third portion 2321, 2323 and parallel with the second portion 2322. The engagement portion 232 is sized and configured such that the second portion 2322, the third portion 2323, and the end portion 2325 are disposed beneath the base portion 230 when the base portion 230 is in the lowered position, as shown in FIG. 21. As shown in FIG. 11, the side wall 1303 of the first portion 130 may be configured to receive a plurality of adapters 150, 152. For example, as illustrated, the third side wall 1303 may include twelve simplex adapters 150, for example, SC adapters, and two multifiber adapters 152, for example, MPO adapters.

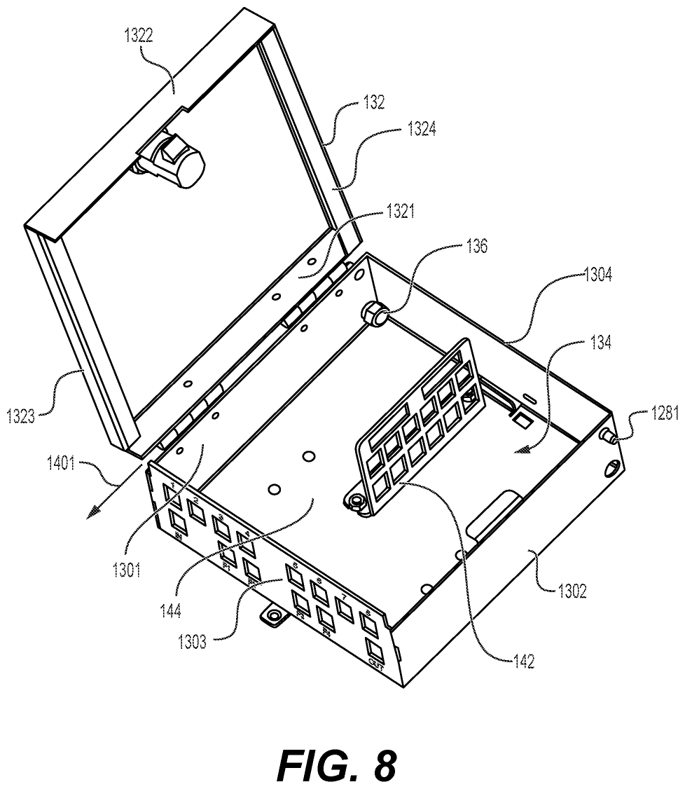

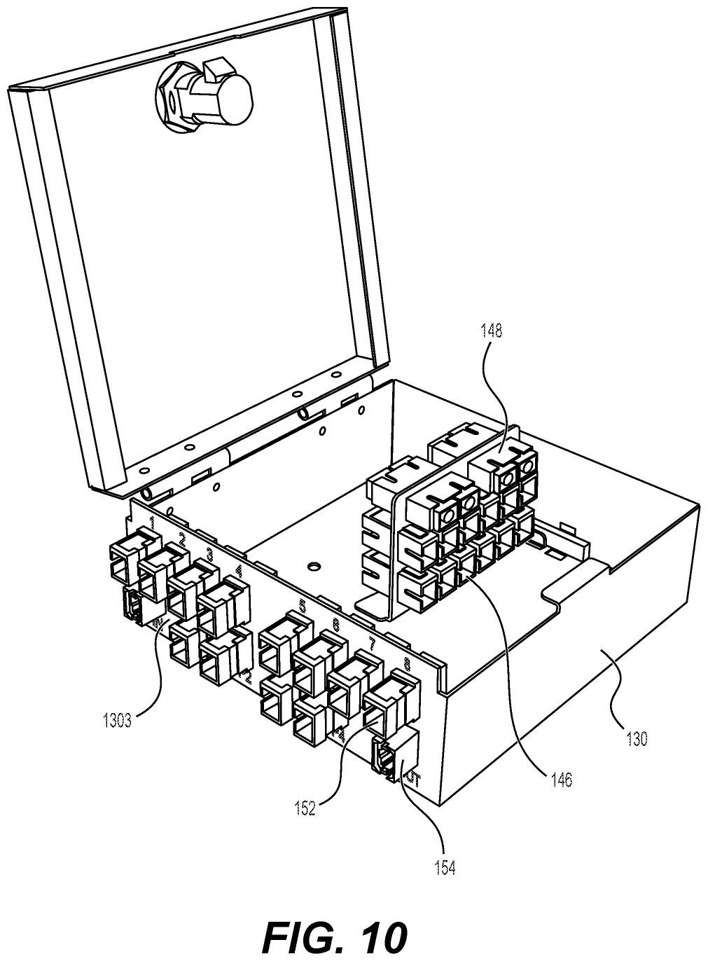

As shown in FIGS. 8 and 10, the first portion 130 may include a support portion 142, for example, a panel, may be configured to extend into the interior 134 of the first portion 130 in a direction perpendicular to a back wall 144 of the first portion 130. The support portion 142 may be configured to receive a plurality of adapters 146, 148. As illustrated, the support portion 142 may include twelve simplex adapters 146, for example, SC adapters, and two parking adapters 148. Each parking adapter 148 may include two inactive ports 1481 configured to receive an unused fiber optic connector, for example, an SC connector.

Referring to FIG. 25, in some aspects, the first portion 130 may include a support portion 242 that includes a mounting portion 2421 configured to be fixedly coupled with the back wall 144 and an adapter receiving portion 2422 that is configured to be removed from the mounting portion 2421. The mounting portion 2421 may include a guide portion 2423, for example, a cutout or channel, configured to receive the adapter receiving portion 2422. The adapter receiving portion 2422 may include a gripping portion 2424 configured to provide a surface to be gripped for pulling the adapter receiving portion 2422 out of the mounting portion 2421. The adapter receiving portion 2422 may be coupled with the mounting portion 2421 with a toolless fastener 2425, such as, for example, a wing nut.

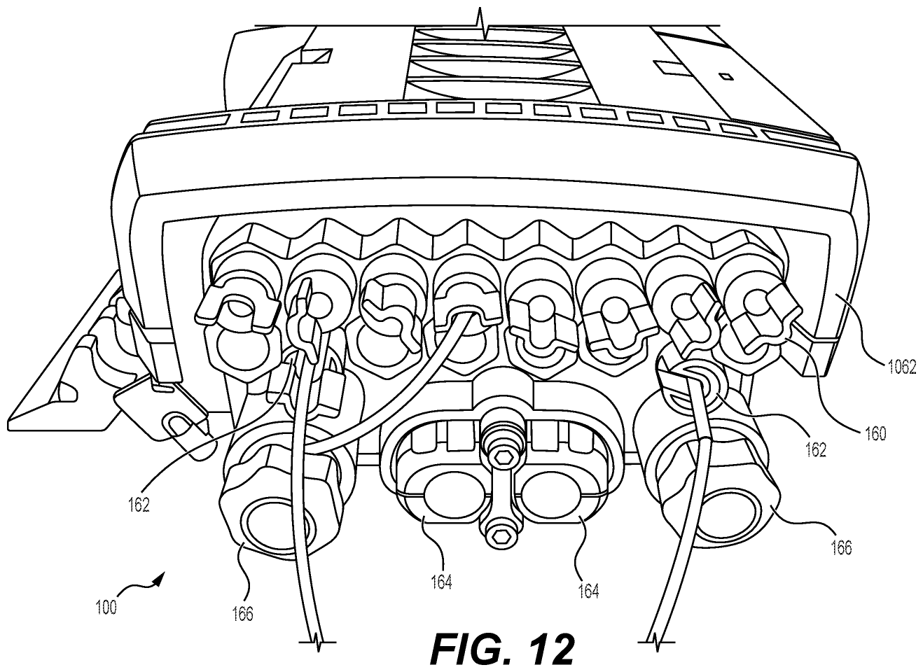

Referring now to FIG. 12, the second side wall 1062 of the first portion 106 of the enclosure 100, which is opposite to the first side wall 1061, is configured to include a plurality of ports 160, 162, 164, 166 configured to pass fiber cables through the second side wall 1062. For example, as illustrated, the plurality of ports may include from one to sixteen ports 160 configured to receive an optical fiber, two ports 162 configured as input and output ports for a multifiber cable, two passthrough ports 164, and two ports 166 that provide an option for additional cable. The two ports may be configured as, for example, twelve fiber MPO ports.

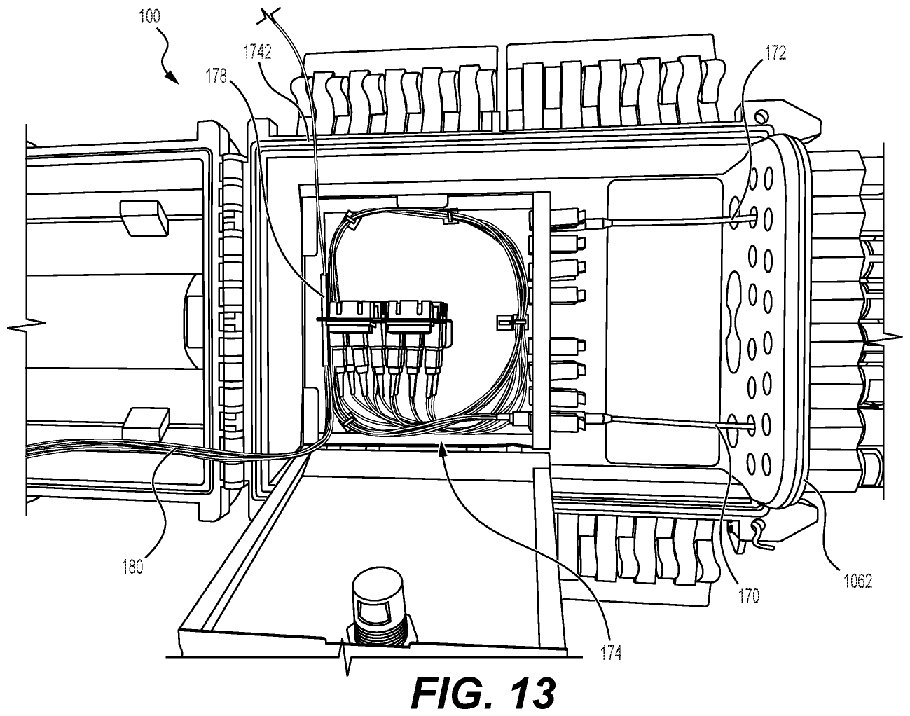

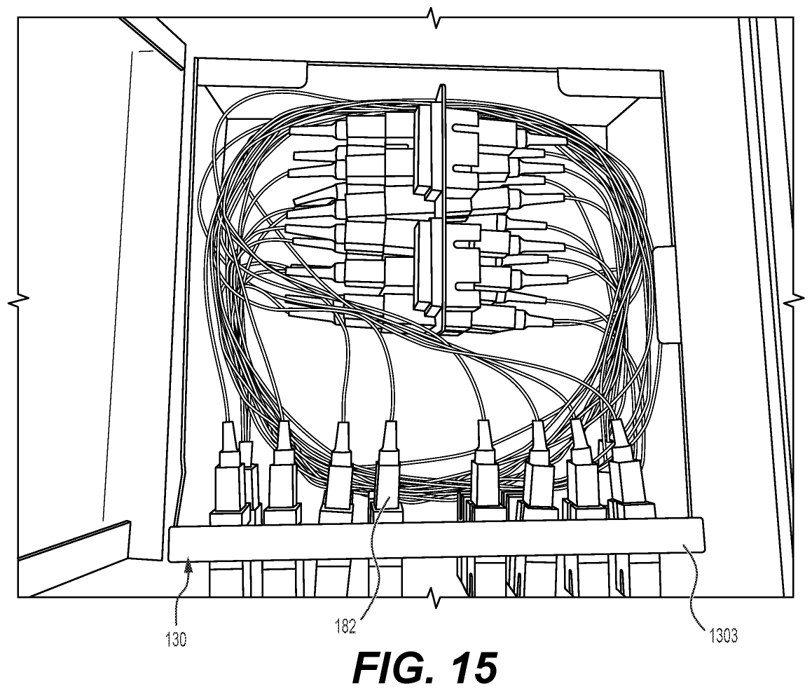

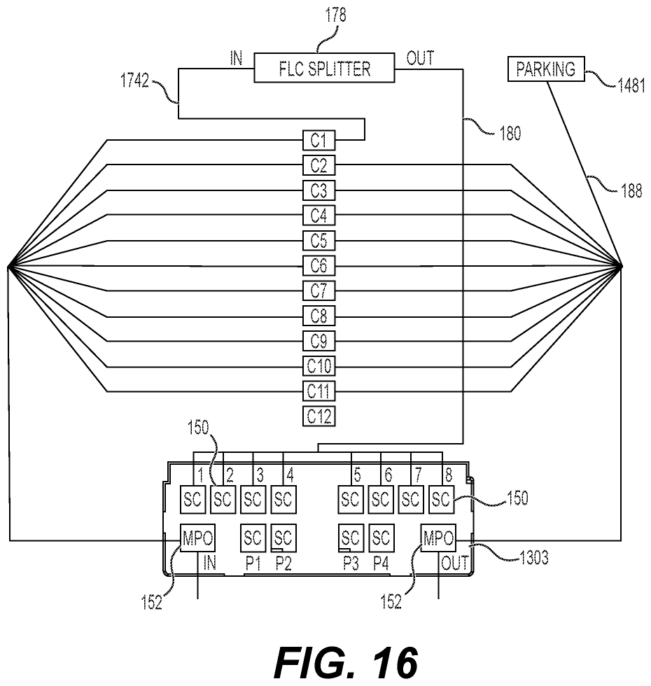

Referring to FIGS. 13-16, the enclosure 120 is shown in a lowered, but opened, position such that the adapters and fibers being routed into and out of the enclosure can be seen. As illustrated, an input multifiber cable 170 and an output multifiber cable 172 enter the through the second side wall 1062 of the enclosure 100. The input multifiber cable 170 is coupled with one of the two multifiber adapters 152, and the output fiber cable 172 is coupled with the other one of the two multifiber adapters 152. In the illustrated embodiment, the input multifiber cable 170 comprises a twelve fiber cable that is broken out into twelve separate fibers 174 at the one adapter 152 that receives the input cable 170. Eleven 1741 of the twelve fibers are connected to eleven of the twelve simplex adapters 146 on the support portion 142 via connectors, for example, SC connectors 176. The twelfth fiber 1742 is coupled with a splitter 178, for example, a 1×8 splitter. The splitter 178 includes eight output fibers 180 that are shown in FIG. 13 before being connected to adapters and are shown in FIG. 15 after being coupled with eight of the twelve simplex adapters 150 at the third side wall 1303 of the first portion 130 via connectors 182, for example, SC connectors.

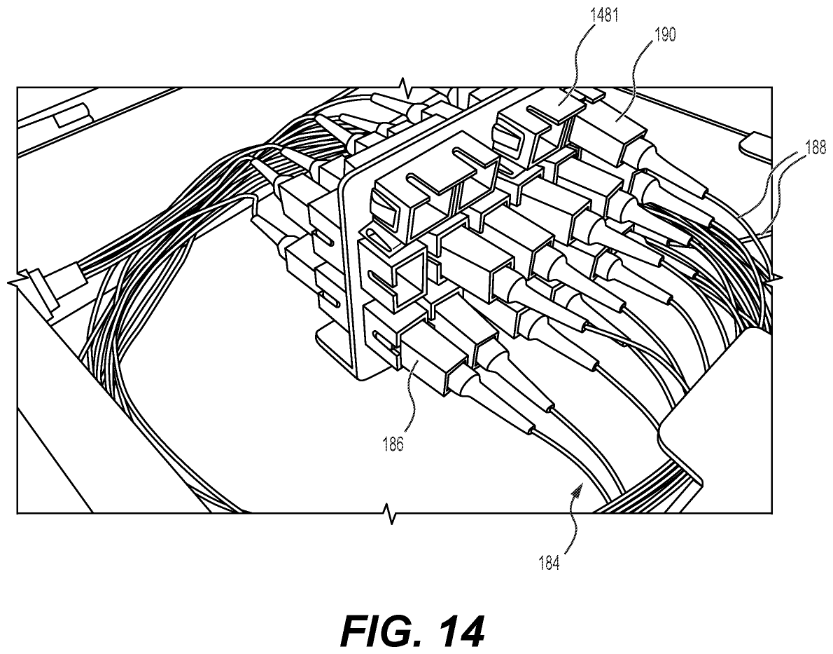

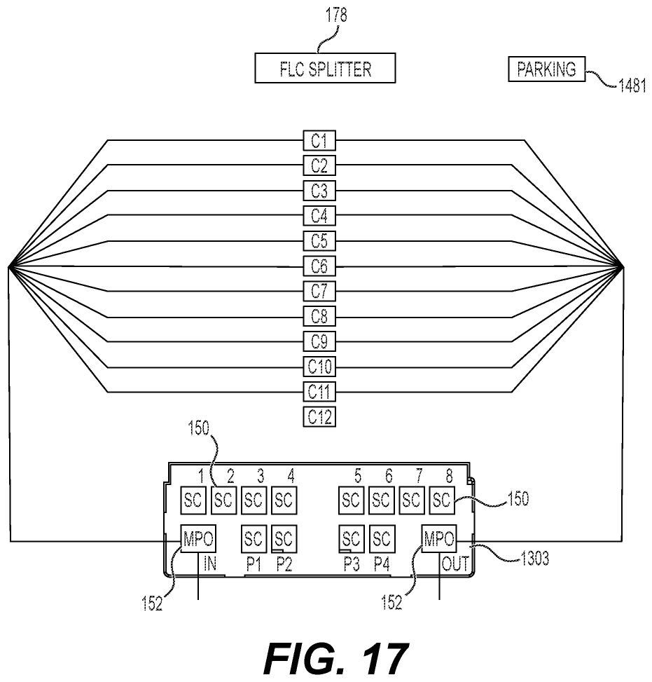

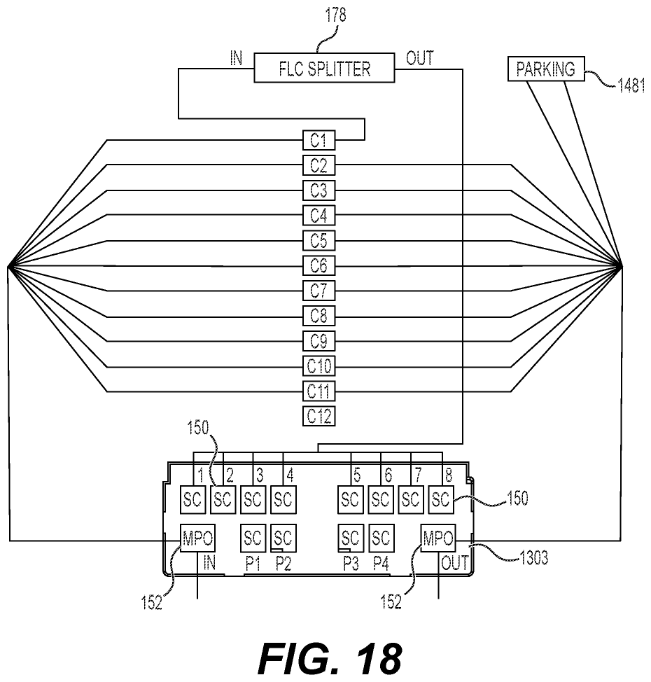

FIG. 14 shows eleven fibers 184 connected via connectors 186, for example, SC connectors, to the eleven of the twelve simplex adapters 146 on the support portion 142 where the eleven 1741 of the twelve fibers are connected. A twelfth fiber 188 is coupled with one of the inactive ports 1481 via a connector 190, for example, an SC connector. The eleven fibers 184 and the twelfth fiber 188 are coupled with the output multifiber cable 172 via an MPO connector (not shown). It should be understood that the configuration of fibers, connectors, adapters, and splitter illustrated in FIGS. 13-15 is merely one example of many possible configurations. FIGS. 17 and 18 illustrate additional exemplary configurations of fibers, connectors, adapters, and splitter.

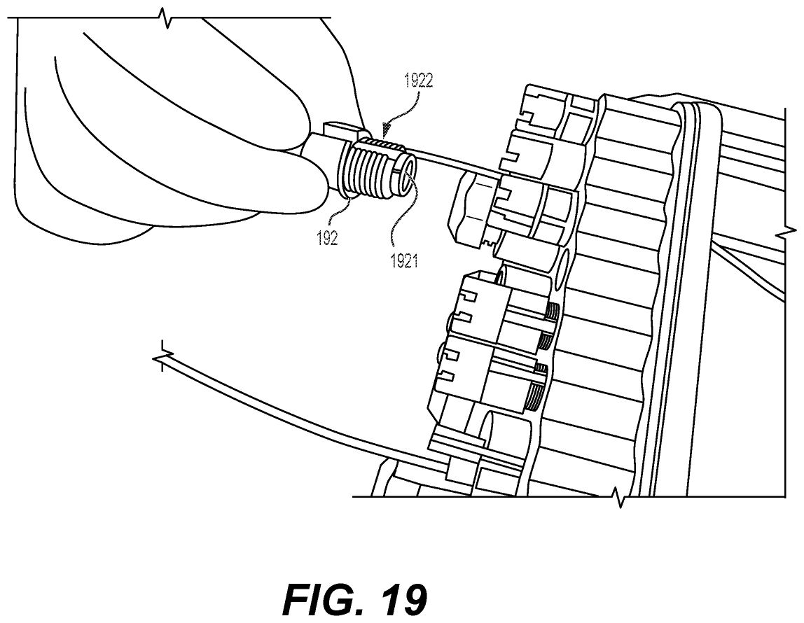

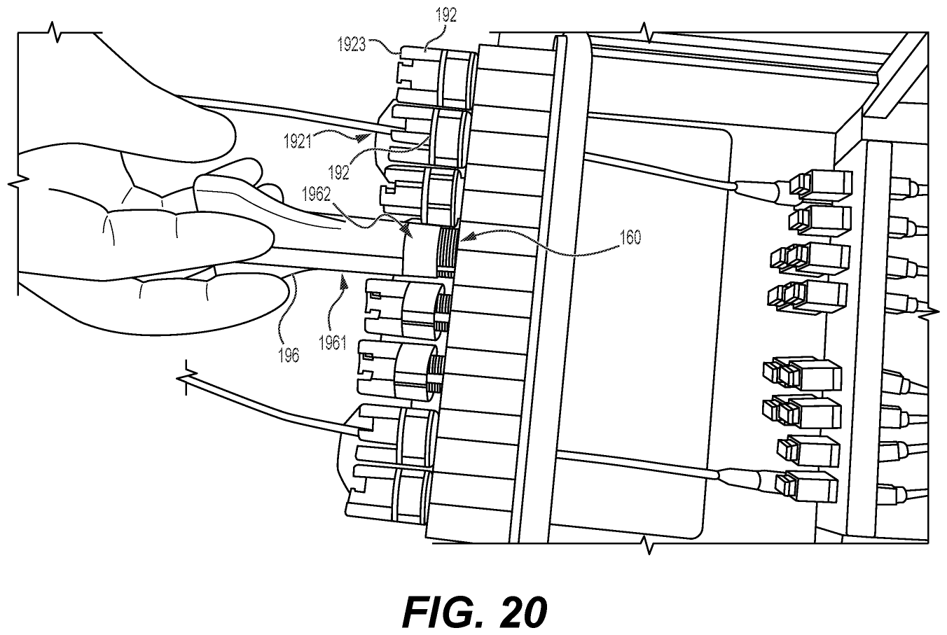

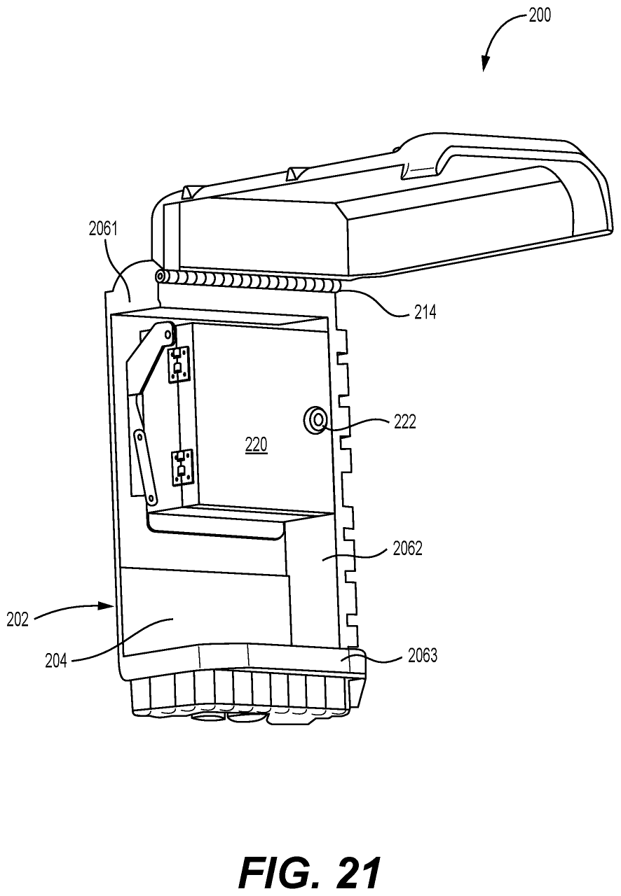

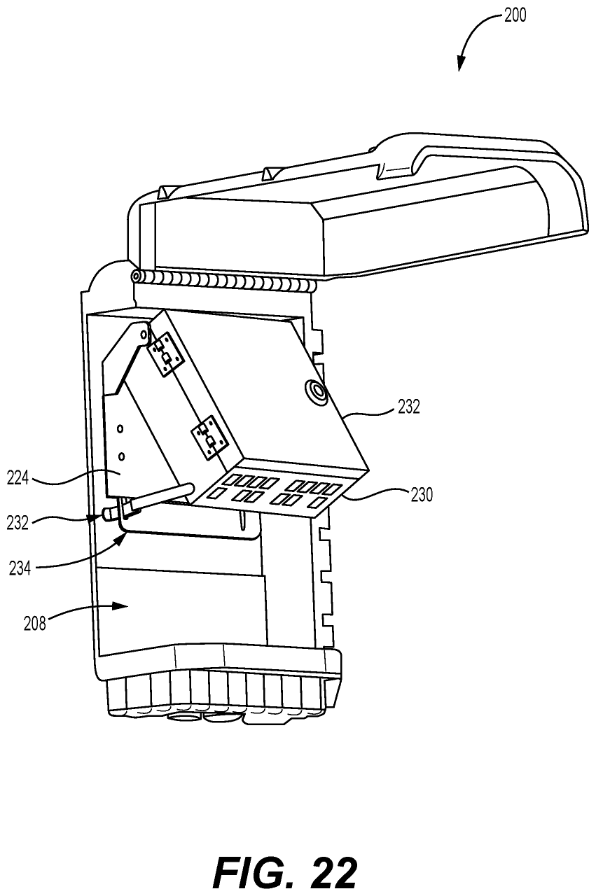

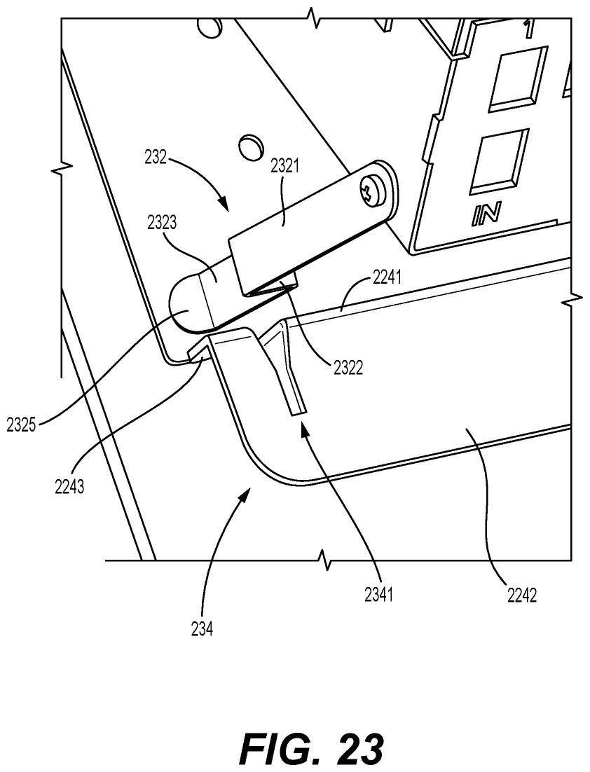

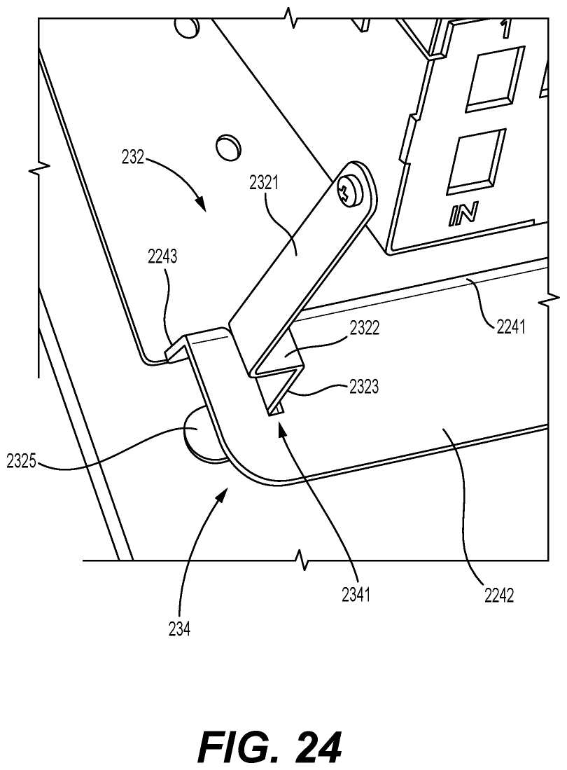

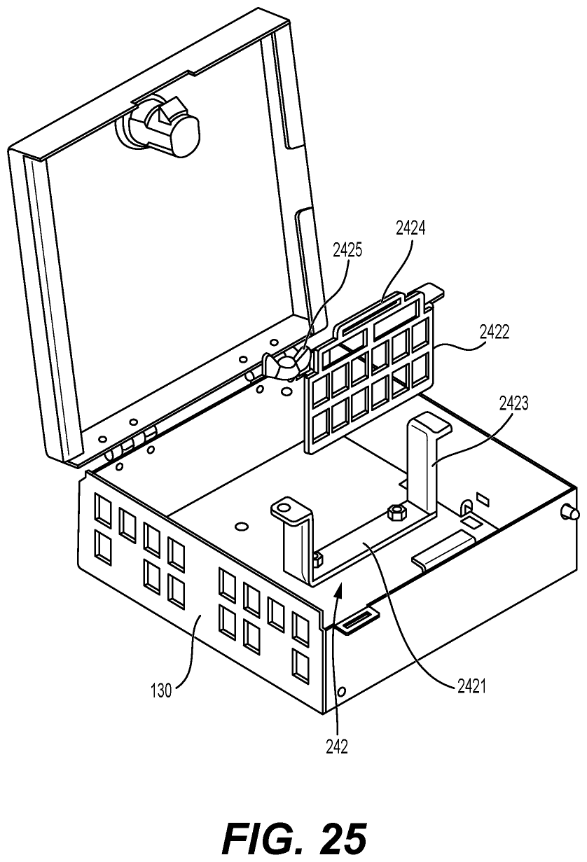

Referring now to FIGS. 19 and 20, one or more of the ports 160 may be configured to receive a port protector 192 configured to permit a fiber cable (not shown), for example, a drop cable, to pass through the port 160 and to maintain the IP rating of the enclosure 100. For example, as illustrated, the port protector 192 may include an axial slot 1921 extending along its entire axial length so as to be configured to receive a fiber cable and a threaded portion 1922 configured to be received by the port 160. FIG. 20 illustrates a tool 196 configured to couple the port protector 192 with the port 160 and to remove the port protector 192 from the port 160. The tool 196 is configured to include an axial slot 1961 extending along its entire axial length so as to be configured to receive a fiber cable. The tool 196 also includes one or more axial notches 1962 that are configured to grip a flange 1923 of the port protector 192.

As described above, the fiber distribution enclosure 100 may be configured as an IP 68 rated box containing 16 individual drop cable IN/OUT options, mid span options, 2 main cable entry/exit options. Inside the enclosure, there is a small patching unit loaded with a 1×8 PLC splitter and 2 pieces of MPO LC fanout terminated with SC APC connectors and options for port parking of 4 connectors.

It should be appreciated that the aforementioned description is directed to the novel features of housing a lock and key based secure metallic box with provisions for MPO or MTP connectivity at the feeder and distribution side of the Optical Network and splitter and pass through features built into the same metallic box with SC/LC connector interface into an IP 68 rated Optical Distribution. The novel features also include the same metallic box is also hinged in order to tilt it upwards up to an angle of 45 degrees in order to clean the end faces of the all the interfaces during the product life cycle. This secured enclosure ensures no access to passive items which prevents damage that could be caused by the installer or by mishandling. Standard drop cable patch cord can be converted to an IP rated connector while using this enclosure, thereby avoiding the use of very expensive overhead connectors for such applications.

Additional embodiments include any one of the embodiments described above, where one or more of its components, functionalities or structures is interchanged with, replaced by, or augmented by one or more of the components, functionalities, or structures of a different embodiment described above.

It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A fiber distribution enclosure comprising:
a base portion having a back wall portion and a side wall portion structurally configured to define an interior;
a cover portion configured to be pivotally coupled with the base portion so as to pivot about a first axis;
a mounting portion configured to be fixedly coupled with the back wall of the base portion in the interior of the base portion;
an enclosure portion configured to be pivotally coupled with the mounting portion in the interior of the base portion;
wherein the enclosure portion includes a first enclosure portion configured to be pivotally coupled with a second enclosure portion about a second axis perpendicular to the first axis;
wherein the first enclosure portion includes a wall portion that is structurally configured to define an interior of the enclosure portion, and the second enclosure portion is structurally configured to block access to the interior of the enclosure portion;
wherein the enclosure portion is structurally configured to enclose a fiber distribution portion in the interior of the enclosure portion;
wherein the enclosure portion includes a locking portion that is structurally configured to lock the second enclosure portion with the first enclosure portion so as to prevent an unauthorized person from accessing the fiber distribution portion;
wherein the wall portion of the first enclosure portion includes an adapter portion that is structurally configured to couple a fiber optic cable from outside of the enclosure portion with a fiber optic cable of the fiber distribution portion so as to permit a person to couple a fiber optic cable to the fiber distribution portion without accessing the fiber distribution portion;
wherein the base portion includes a port portion that is structurally configured to permit a fiber optic cable to pass there through for coupling with the adapter portion;
wherein the cover portion is structurally configured to be moved between a closed position, which prevents access to the enclosure portion, and an open position, which permits access to the enclosure portion;
wherein the first enclosure portion is structurally configured to be moved relative to the base portion between a lowered position and a raised position; and
wherein the first enclosure portion includes an engagement portion structurally configured to engage a receiving portion of the mounting portion such that the engagement portion and the receiving portion are structurally configured to maintain the first enclosure portion in the raised position so as to provide enhanced access to the adapter portion of the enclosure portion when the cover portion is in the open position.

2. The enclosure of claim 1, wherein the engagement structure comprises a biasing portion extending from the first enclosure portion, and the receiving portion is structurally configured to receive the biasing portion.

3. The enclosure of claim 2, wherein the biasing portion comprises a spring-biased plunger mounted in a side wall of the first enclosure portion, and the receiving portion comprises a hole or notch in the mounting portion.

4. The enclosure of claim 1, wherein the mounting portion comprises two arms and each arm includes a notch, and the enclosure portion comprises two pins extending in an opposite direction from two opposite side walls of the enclosure; and
wherein the arms are spaced apart from one another by a distance that is large enough to permit the enclosure portion to be received therebetween and small enough such that the notches are structurally configured to receive the pins so as to permit the enclosure portion to pivot relative to the mounting portion.

5. The enclosure of claim 4, wherein each notch is configured to require that the pin be moved in two directions in order to remove the pin from the notch so as to prevent inadvertent removal of the pin from the notch.

6. The enclosure of claim 1, wherein the adapter portion includes a single fiber adapter and a multifiber adapter;
wherein the fiber distribution portion includes a single fiber adapter, a splitter, and a parking portion; and
wherein the port portion includes input and output ports each configured to receive a multifiber cable, and a drop cable portion.

7. A fiber distribution enclosure comprising:
a base portion;
a cover portion structurally configured to be coupled with the base portion;
an enclosure portion structurally configured to be pivotally coupled with the base portion at an interior of the base portion;
wherein the enclosure portion includes a first enclosure portion structurally configured to be coupled with a second enclosure portion so as to prevent an unauthorized person from accessing a fiber distribution portion in the interior of the enclosure portion;
wherein the enclosure portion includes an adapter portion that is structurally configured to couple a fiber optic cable from outside of the enclosure portion with a fiber optic cable of the fiber distribution portion so as to permit a person to couple a fiber optic cable to the fiber distribution portion without accessing the fiber distribution portion;
wherein the first enclosure portion is structurally configured to be pivoted relative to the base portion between a lowered position and a raised position; and
wherein the first enclosure portion includes an engagement portion structurally configured to engage a receiving portion of the mounting portion in the raised position such that the engagement portion and the receiving portion are structurally configured to maintain the first enclosure portion in the raised position so as to provide enhanced access to the adapter portion of the enclosure portion when the cover portion is in an open position that permits access to the interior of the base portion.

8. The enclosure of claim 7, wherein the engagement portion comprises a biasing portion extending from the first enclosure portion, and the receiving portion is structurally configured to receive the biasing portion.

9. The enclosure of claim 8, wherein the biasing portion comprises a spring-biased plunger mounted in a side wall of the first enclosure portion, and the receiving portion comprises a hole or notch in the base portion.

10. The enclosure of claim 7, wherein the base portion includes a mounting portion comprising two arms and each arm includes a notch, and the enclosure portion comprises two pins extending in an opposite direction from two opposite side walls of the enclosure; and
wherein the arms are spaced apart from one another by a distance that is large enough to permit the enclosure portion to be received therebetween and small enough such that the notches are structurally configured to receive the pins so as to permit the enclosure portion to pivot relative to the mounting portion.

11. The enclosure of claim 10, wherein the mounting portion is structurally configured to be coupled with a wall of the base portion.

12. The enclosure of claim 10, wherein each notch is configured to require that the pin be moved in two directions in order to remove the pin from the notch so as to prevent inadvertent removal of the pin from the notch.

13. The enclosure of claim 7, wherein the base portion includes a port portion that is structurally configured to permit a fiber optic cable to pass there through for coupling with the adapter portion.

14. The enclosure of claim 13, wherein the adapter portion includes a single fiber adapter and a multifiber adapter;
wherein the fiber distribution portion includes a single fiber adapter, a splitter, and a parking portion; and
wherein the port portion includes input and output ports each configured to receive a multifiber cable, and a drop cable portion.

15. A fiber distribution enclosure comprising:
a base portion;
a cover portion structurally configured to be coupled with the base portion;
an enclosure portion structurally configured to be pivotally coupled with the base portion at an interior of the base portion;
wherein the enclosure portion includes an adapter portion that is structurally configured to couple a fiber optic cable from outside of the enclosure portion with a fiber optic cable of a fiber distribution portion in the enclosure portion so as to permit a person to couple a fiber optic cable to the fiber distribution portion without accessing the fiber distribution portion;
wherein the first enclosure portion is structurally configured to be pivoted relative to the base portion between a lowered position and a raised position; and
wherein the first enclosure portion includes an engagement portion structurally configured to engage a receiving portion of the mounting portion in the raised position such that the engagement portion and the receiving portion are structurally configured to maintain the first enclosure portion in the raised position so as to provide enhanced access to the adapter portion of the enclosure portion when the cover portion is in an open position that permits access to the interior of the base portion.

16. The enclosure of claim 15, wherein the engagement portion comprises a biasing portion extending from the first enclosure portion, and the receiving portion is structurally configured to receive the biasing portion.

17. The enclosure of claim 16, wherein the biasing portion comprises a spring-biased plunger mounted in a side wall of the first enclosure portion, and the receiving portion comprises a hole or notch in the base portion.

18. The enclosure of claim 15, wherein the base portion includes a mounting portion comprising two arms and each arm includes a notch, and the enclosure portion comprises two pins extending in an opposite direction from two opposite side walls of the enclosure; and
wherein the arms are spaced apart from one another by a distance that is large enough to permit the enclosure portion to be received therebetween and small enough such that the notches are structurally configured to receive the pins so as to permit the enclosure portion to pivot relative to the mounting portion.

19. The enclosure of claim 18, wherein the mounting portion is structurally configured to be coupled with a wall of the base portion.

20. The enclosure of claim 18, wherein each notch is configured to require that the pin be moved in two directions in order to remove the pin from the notch so as to prevent inadvertent removal of the pin from the notch.

21. The enclosure of claim 15, wherein the base portion includes a port portion that is structurally configured to permit a fiber optic cable to pass there through for coupling with the adapter portion.

22. The enclosure of claim 15, wherein the adapter portion includes a single fiber adapter and a multifiber adapter;
wherein the fiber distribution portion includes a single fiber adapter, a splitter, and a parking portion; and
wherein the port portion includes input and output ports each configured to receive a multifiber cable, and a drop cable portion.

23. The enclosure of claim 15, wherein the enclosure portion is structurally configured to prevent an unauthorized person from accessing a fiber distribution portion in an interior of the enclosure portion.
